(19) United States
(12) Patent Application Publication
(10) Pub. No.: US 2003/0026612 A1
(43) Pub. Date: Feb. 6, 2003

(54) Print service

(75) Inventor: Tadashi Ohta, Yokohama-shi (JP)

Correspondence Address: OLIFF & BERRIDGE, PLC, P.O. BOX 19928, ALEXANDRIA, VA, 22320, US

(73) Assignee: NIKON CORPORATION, NIKON TECHNOLOGIES INC.

(21) Appl. No.: 09/802,844

(22) Filed: Mar. 12, 2001

(30) Foreign Application Priority Data
Mar. 16, 2000 (JP) JP 2000-074330

(51) Int. Cl. G03B 17/48

(52) U.S. Cl. 396/429

(57) ABSTRACT

The present invention aims to provide a system that induces users to make orders for additional prints in a similar sense as making additional prints in the conventional silver-halide film photography system. In a print service that provides print output of image data to an order from a user, in case that a repeat order is placed from said user, different charge system from that applied last time is applied based on the date of the previous order.

### BACKGROUND OF THE INVENTION

1. Field of the Invention

The present invention relates to a print service that provides users with photo print service via a network such as the Internet.

2. Description of the Related Art

To this date, services under such name as ‘photo net service’ for printing out digital image data is known.

In these services, an order for prints is made at a shop counter by a user with bringing a floppy disc or an MO disc that stores images in the JPEG format, or from the user's personal computer to the order form displayed on the web page of a print maker is filled in and the image data is transmitted, and finished prints are received at the shop counter in both cases. In these existing print services, either at the counter or via the Internet, a fixed basic charge is charged in addition to the cost of prints under the name of the technical charge mainly for operating an apparatus for making prints.

In these services, even for an order for one or two additional prints the basic charge is charged again and as a result the unit price of the print is increased and users are discouraged to make additional print orders. As a countermeasure to this, it is possible to put a few orders for additional prints from different users together and avoid to charge the basic charge at a laboratory or a counter, but in this way, the method of charging may differ from laboratory to laboratory and the procedure of charging will be complicated and, more over, these circumstances may hardly be understood by users.

The present invention is made in consideration of these existing problems and aims for providing a system that induces users to make orders for additional prints in a similar sense as making additional prints in conventional silver-halide film photography system.

### SUMMARY OF THE INVENTION

In order to overcome the problems and disadvantages, the invention provides a print service for providing print of digital image data in response to an order from a user comprising a recorder that records reception date of an order from the user and data identifying the user, a checker that checks whether or not a previous order from the same user is in the record of the recorder within a predetermined period prior to the order of this, and a charge determiner that deducts a predetermined amount from the print charge on the order of this time regardless of that on the previous order if the checker finds the previous order in the record.

This makes it possible that the lower print charge is applied as far as the print order is repeated within the predetermined period and it is expected to keep frequent customers. By means of the checker that checks up the data identifying the user and the reception date of the order, the user and the predetermined period are identified with ease.

Further by means of the checker that checks up whether or not the user used the same print service or the same service front within the predetermined period, the service charge may be determined at the print service or the service front independently.

As the contents recorded by the recorder are attached to or embedded in the digital image data, the print history of the image can be traced by looking into the data related to the image ordered to print, and the print charge may be determined according to the print history.

According to another feature of the invention, a print service for providing print of digital image data in response to an order from a user comprising a recorder that records reception date of an order from the user and data identifying the user, a checker that checks whether or not a previous order from the same user is in the record of the recorder within one month prior to the order of this time, and a charge determiner that deducts an amount from the print charge on the order of this time if the checker finds the previous order in the record.

Since the lower print charge is determined by means of this determiner, the lower print charge is applied to any number of orders as far as they are made within the predetermined period set long enough even for the order that relates to the first print order such as the order for prints that were failed to order last time or the order for additional prints so that it may provide users with low-priced prints, and thus it is expected to keep frequent customers. By means of the checker that also checks up the data identifying the user and the reception date of the order, the user and the predetermined period are identified with ease.

According to further feature of the invention, in a print service for providing print of digital image data in response to an order from a user, a laboratory system comprising a recorder that records data identifying the user, a checker that checks whether or not the user used the same laboratory system before according to the record, a determiner that determines the print charge on the order of this time in response to the checker, and a reporter that reports the outcome of the determiner to a service front that contacts the user.

By means of the checker above, it is checked up if the data identifying the user of this time recorded by the recorder has been recorded before and the recorder that records the name of a reception site that received the print order or the name of a delivery site that delivers the print output to the user, and the reporter reports the reception site or the delivery site recorded in the record of the outcome of the determiner, any of sites that received the report may easily determine the print charge.

According to still further feature of the invention, in a print service for providing a print of digital image data in response to an order from a user through a service front, the service front comprising a first recorder that records data identifying the user, a second recorder that records a laboratory system, the service front requesting the recorded laboratory system to produce the print a checker that checks whether or not the user used the same service front before according to the record of the first recorder, and a determiner that determines the print charge on the order of this time in response to the checker regardless of the record of the second recorder.

Therefore the charge for the service front alone may easily be determined regardless of the description of the laboratory system designated by the user.

Further the service front of the system includes the requester that requests the print to the laboratory system according to the record of the second recorder and receiver that receives the report of the charge determined by the laboratory system, and, a charging system that charges the user the total amount of the reported charge and the charge determined by the determiner, thus the total amount of the print charge including the charge for the laboratory system may easily be determined.

Still further the service front acts as a reception site that receives an order for printing images from the user or a delivery site that delivers the print output to the user, thus either of them may easily determine the sum of the print charge.

Other features and advantages according to the invention will be readily understood from the detailed description of the preferred embodiments in conjunction with the accompanying drawings.

### BRIEF DESCRIPTION OF THE DRAWINGS

FIG. 1 is a block diagram showing an embodiment of the print service of the present invention.

FIG. 2 is a block diagram showing another embodiment of the print service of the present invention.

FIGS. 3 and 4 are flowcharts showing the distribution of the material in the block diagram of FIG. 1.

FIG. 5 is a flowchart showing the distribution of the material in the block diagram of FIG. 2.

FIGS. 6 and 7 are drawings illustrating a user individual file that records the user information at the laboratory.

FIGS. 8 and 9 are drawings illustrating a user individual file that records the user information at the reception counter.

FIG. 10 is a flowchart that confirm the history mainly of the images received.

### DETAILED DESCRIPTION OF THE PREFERRED EMBODIMENTS

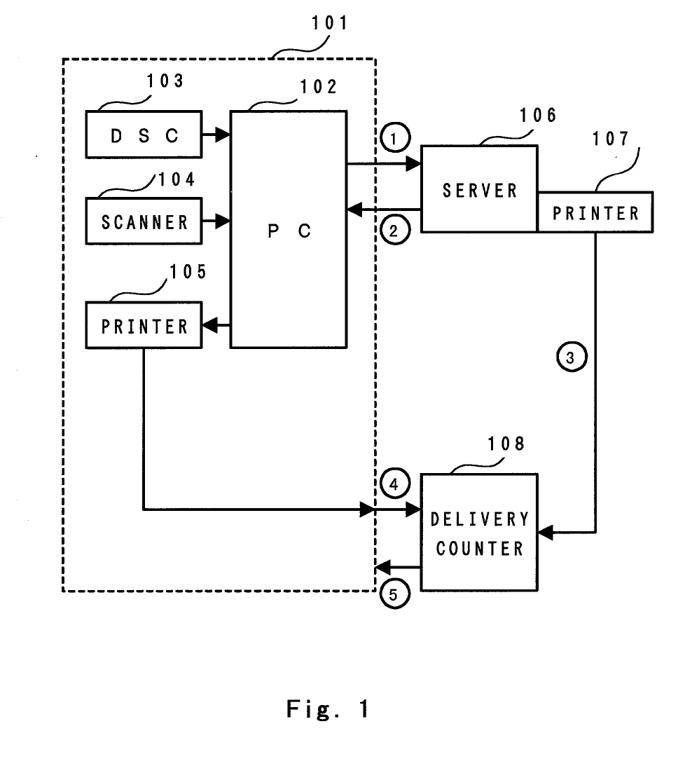

Now, the preferred embodiment of the present invention will be described. FIG. 1 shows a block diagram regarding the print service of the present invention. A user has personal computer 102 at user's home 101 that can be connected to a network, and to this personal computer 102, digital image can be input from digital camera 103 or scanner 104, or, from this personal computer, text data or image signal can be output to printer 105. This personal computer 102 can be connected to more than one servers via such network as the Internet and here, it is connected to server 106 of A Corporation's laboratory that provides the printing service of digital image to the silver-halide print paper, and it shows the case in which the reception page for a print order on the web pages of A Corporation is selected and image data for printing are transmitted to A Corporation's laboratory.

The image data received by server 106 are printed to silver-halide print paper with the printer installed at the A Corporation's laboratory, and the output print is delivered to the delivery counter 108 of a mini-laboratory or a convenience store designated by the user. In this case, it is described that the server and the printer are installed at A Corporation's laboratory, but they can be installed separately and if the printer is installed at the handling counter, the print can be handed to the user earlier by utilizing it.

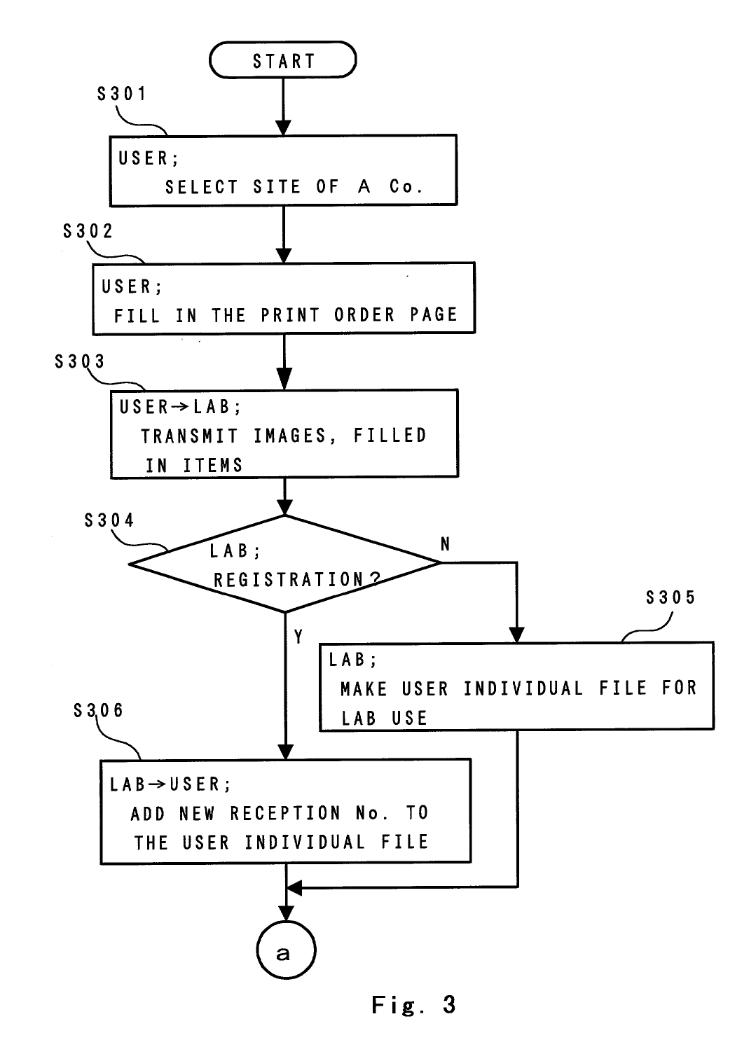

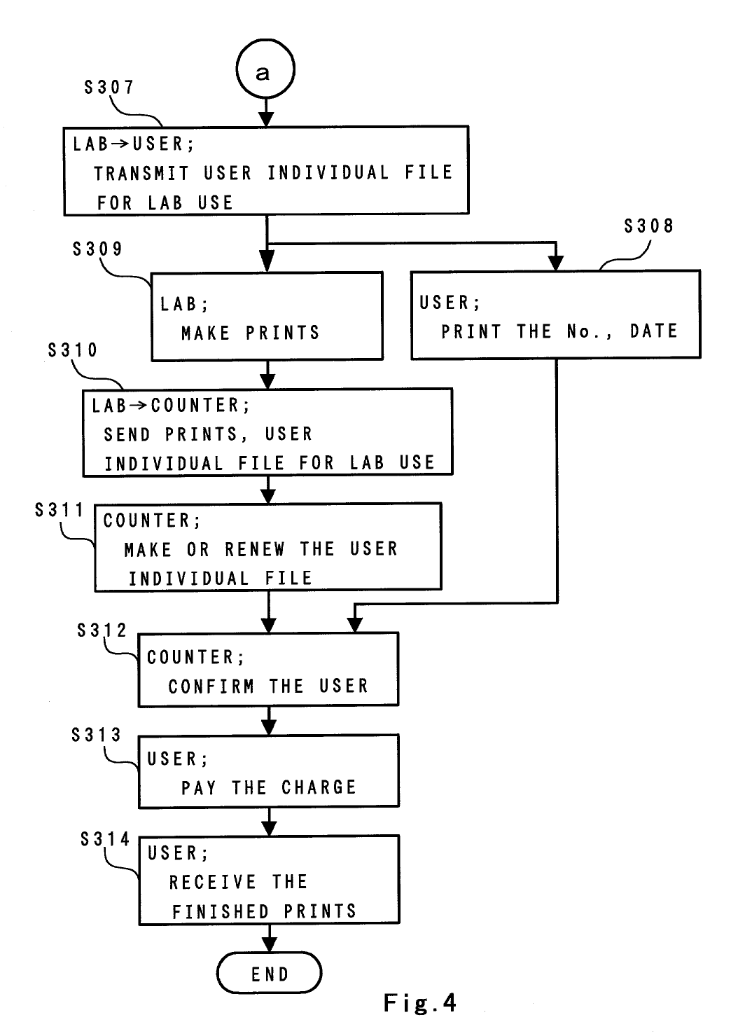

Now the flow of signals and goods of FIG. 1 can be explained based on the flowcharts of FIGS. 3 and 4. First, the user connects personal computer 101 to the Internet and selects the page for reception of the print order from the pages of A corporation's laboratory in step S301. Then, the user fills in step S302 user name, own telephone number and the registration number if it has been registered before, and they are transmitted to A corporation's laboratory together with the images to print (FIG. 1\mathring{1}). At this time, the address, print size, individual and entire number of prints should be transmitted.

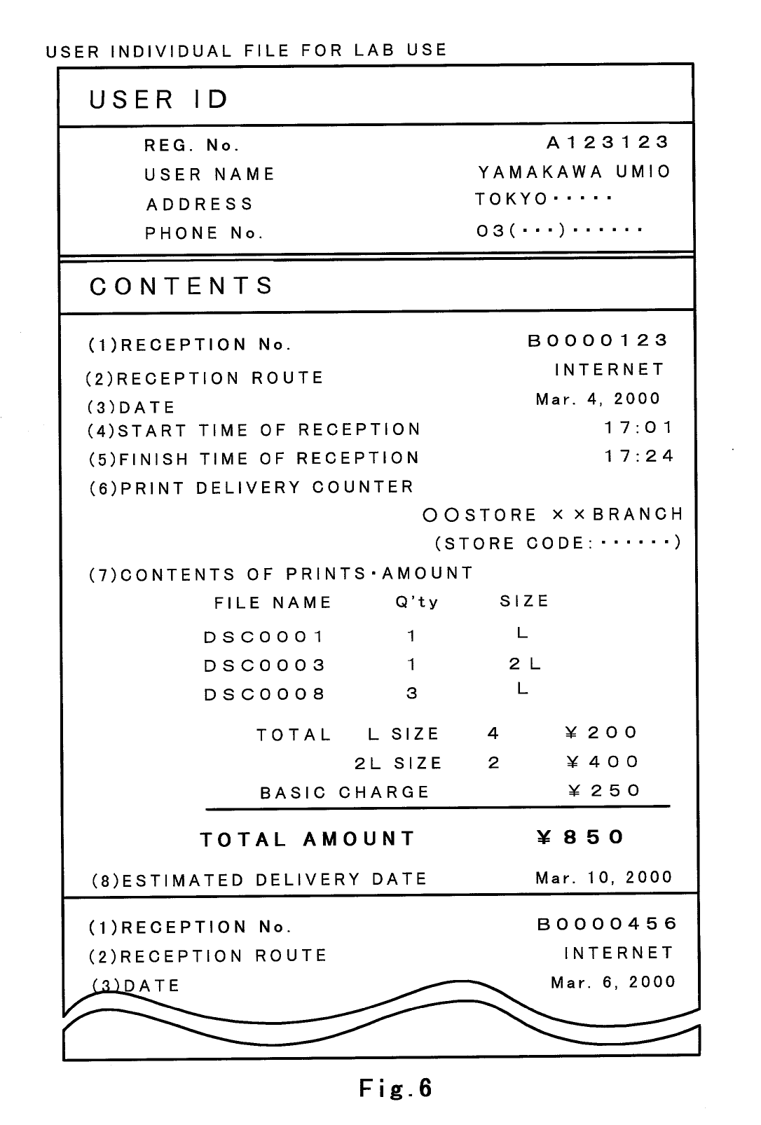

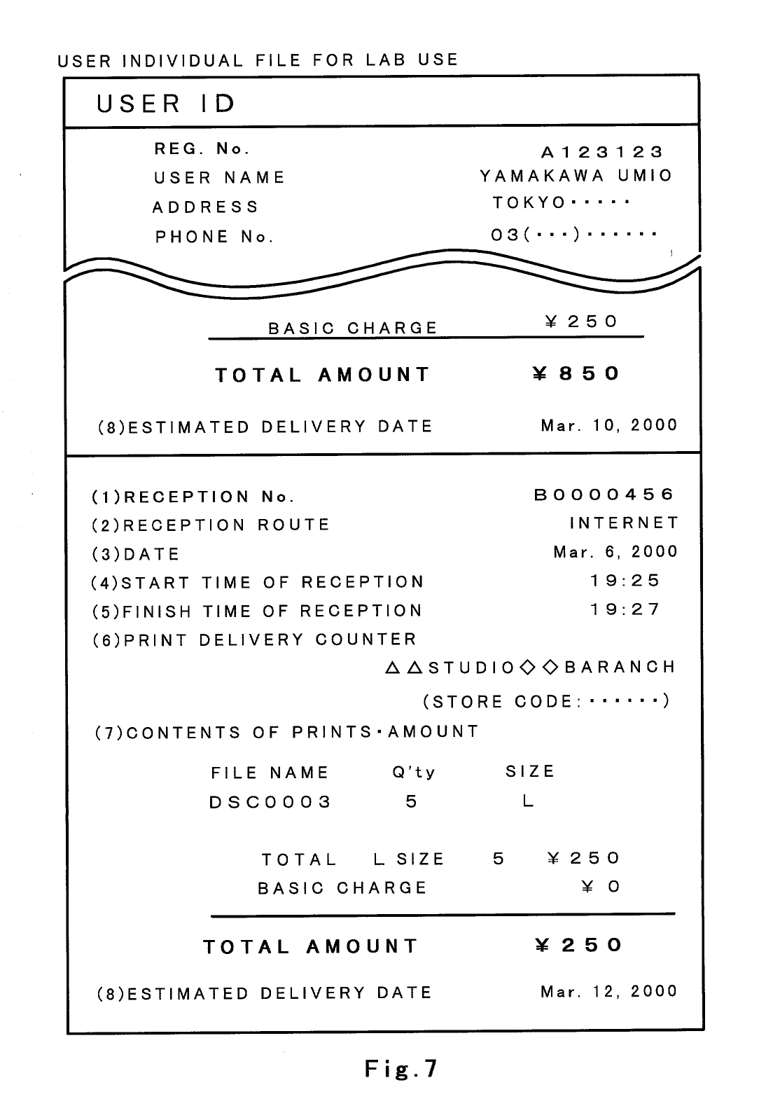

Then, A corporation's laboratory searches the user based on the registration No. etc., from individual user files for laboratory use (FIGS. 6 and 7 : details are described later) made beforehand according to the fixed format in step S304. If there is no registration No. corresponding to the name and address sent this time, the user is not registered yet, and in that case, a new individual user file for laboratory use should be made and the registration No. and other items should be recorded. If the individual user file for laboratory use with registration No. same as the number sent by the user this time exists, the step is immediately proceeded to step S306 and new reception No. corresponding to the print order of this time is established in the area for the contents of reception in said individual user file for laboratory use and required items such as the date and time of the start and finish of the reception, print size, number of prints, and so on should be recorded.

If the registration of these is finished, the laboratory transmits the individual user file made a little while ago to the user in step S307 (FIG. 1\mathring{1}), and the user checks it and prints the content sent from the laboratory in step S308, and presents it to the delivery counter 108 (FIG. 1\mathring{4}) in order to receive the prints in step S312.

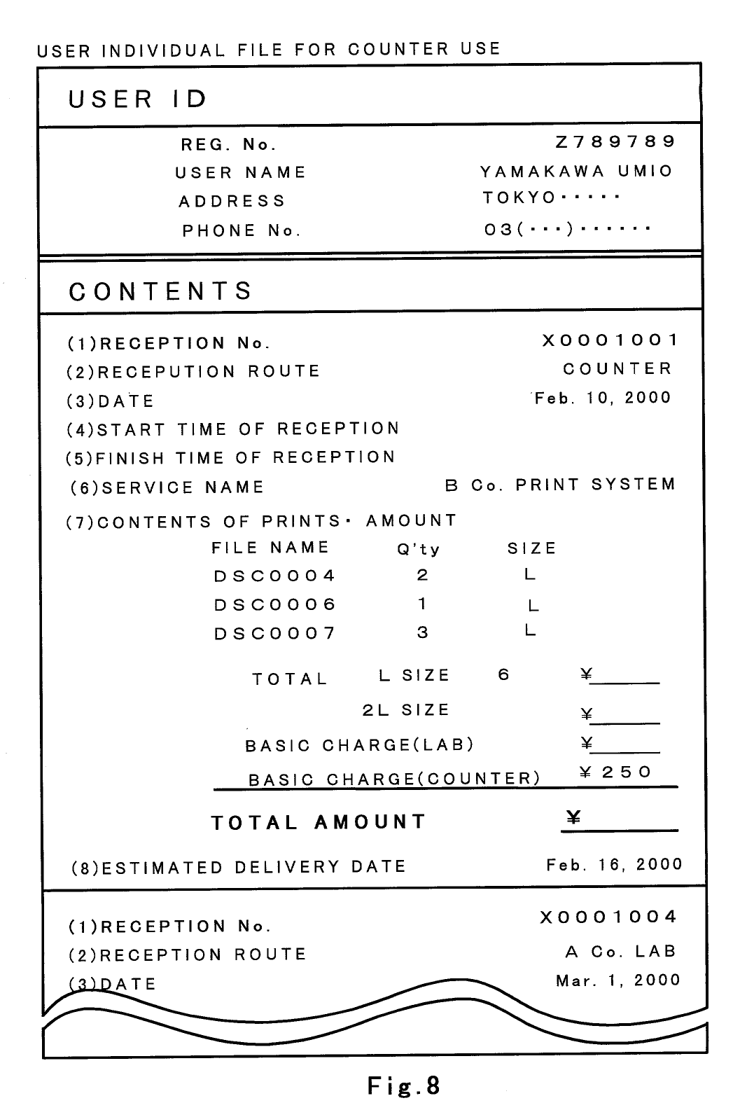

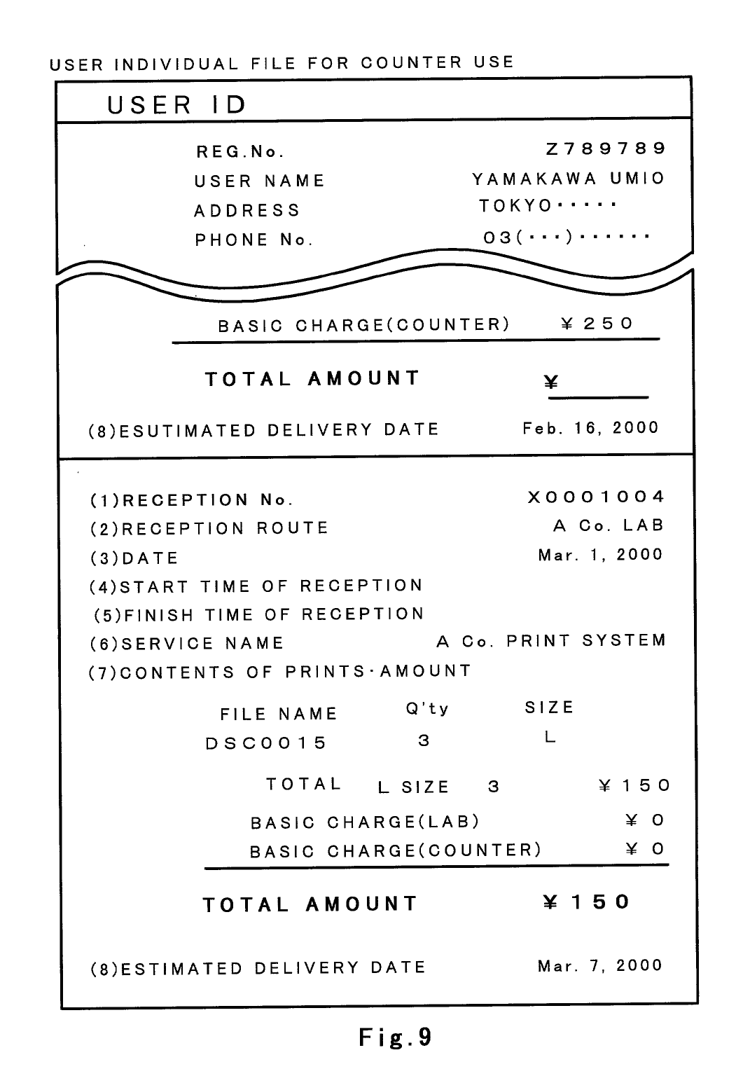

On the other hand, the laboratory makes the ordered prints based on the individual user file for laboratory use and the transmitted image file in step S309 and dispatches these finished prints and the individual user file for laboratory use together to delivery counter 108 designated by the user (FIG. 4 step 310, FIG. 1\mathring{3}). At that time, it is not necessary to send the printed pictures and the individual user file in the same package, but the individual user information for laboratory use (or the part of it) may be transmitted via the network separately. Then, the delivery counter 108 makes the individual user file for counter use in step 311 (FIGS. 8 and 9: details are described later) based on the individual user file for laboratory use dispatched or transmitted from the laboratory.

The delivery counter 108 checks the order information that the user printed out and brought with the individual user information for counter use in step 312, and if there is not a problem, receives payment from the user in step S313 (FIG. 1\mathring{4}) and delivers the prints to the user in step 314 (FIG. 1\mathring{5}), thus the series of process are finished.

Now the individual user file for laboratory use (FIGS. 6 and 7) and the individual user file for counter use (FIGS. 8 and 9) appeared in the description so far will be explained. However, the basic charge that the user paid every time at the new print order is fixed at 500 yen per order and to be split by the laboratory and the counter fifty-fifty.

First, the individual user file for laboratory use that is used for managing the user information at the laboratory end will be explained based on FIGS. 6 and 7. As is known from FIGS. 6 and 7, this file consists of two areas mainly, the user ID area and the reception contents area. The contents of user ID area, once registered, for example, the address or telephone number, are seldom renewed unless requested by the user to change.

Now, the explanation is made to the reception contents area item by item. First, at every new order, (1) new reception NO. is established. In (2) the route of reception, it is recorded with discrimination if the print order of this time is received directly from the user via the Internet, or received by the counter in the general market with MO presented by the user and then the order is directed to this laboratory. (3) is for reception date, and (4) and (5) are for the time of the start and finish of receiving the data in case of reception via the Internet. (6) is for delivery counter of the printed pictures designated by the user via the Internet. It is also the reception counter in case of via convenience store in before-mentioned (2) route of reception. And, though the case is very scarce, even if the delivery counter is different from the reception counter, it can be coped with easily by adding one more item. (7) is an item for filling in the number of images sent this time, the number of prints and the amount to be charged.

Among these, regarding the basic charge, while ¥250 is charged for the first order, for the order after that (2nd time shown in FIG. 7, the case of Reception No. B0000456), for instance, nothing is charged because it is within a week from the previous order. As for the discount of the basic charge, it is possible to establish a few discount rates such as, free of charge for the order within a week and 50% for the order within a month, and the starting date may be set at the date of the first order or that of the previous order. It is also easy to establish the similar discount system for the total amount. (8) is the estimated date and time of finishing prints at this laboratory.

Now, the individual user file for reception counter use will be explained based on FIGS. 8 and 9, and it is very similar to the individual user file for laboratory use explained earlier. User ID area is similar to that of user file for laboratory use. However, among them, the registration NO. is proper to respective counter and is different from those of the laboratory or other counters. Regarding reception contents area, necessary items will be explained one by one. For (2) Reception route, it is recorded with discrimination if the print order is made by presenting MO by the user to the counter directly, or it is ordered via the Internet and this counter is designated by the user as the delivery counter for finished prints.

(4) and (5) time of start and finish of receiving data are not necessary for general counter such as convenience store, but, if the counter has the printing facility, it is much faster to deliver the finished prints by receiving the data via the Internet than by receiving the graphics data from the server, and in that case, the time of start and finish of receiving the data from laboratory are recorded. (6) is for recording the name of print service system that is designated by the user at the counter. (7) is for the details of order of this time, and in the first case (FIG. 8), the column for the amount is not filled in except the amount relating directly to the reception counter, and, the rest is filled in later time when the finished prints are delivered and the basic amount relating to the laboratory is confirmed. In the second case shown in FIG. 9 (the case of Reception No. X0001004), this reception counter makes it a rule that the basic charge is set ¥0 if the order is placed within a month from the previous order, and at the laboratory it is also set ¥0 because of the past history of order of this user as mentioned above.

In this way, in the case of this FIG. 1, user registration at A Corporation is completed when the user designated the print system of A Corporation, and user registration of the reception counter is completed when A Corporation requested the counter to deliver the finished prints. Later on, as far as the user uses the same print system and the counter repeatedly, the best discount rate is applied to the user. On the other hand, in case that the user uses A Corporation's laboratory system for the print system and designates a different handling counter than that of this time, the discount relating to the laboratory system alone is applied to the user.

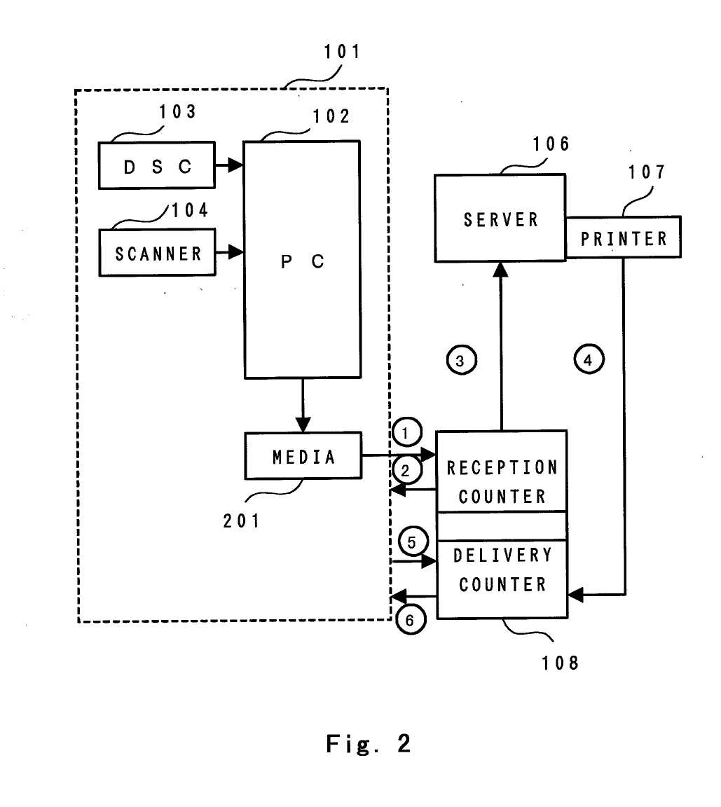

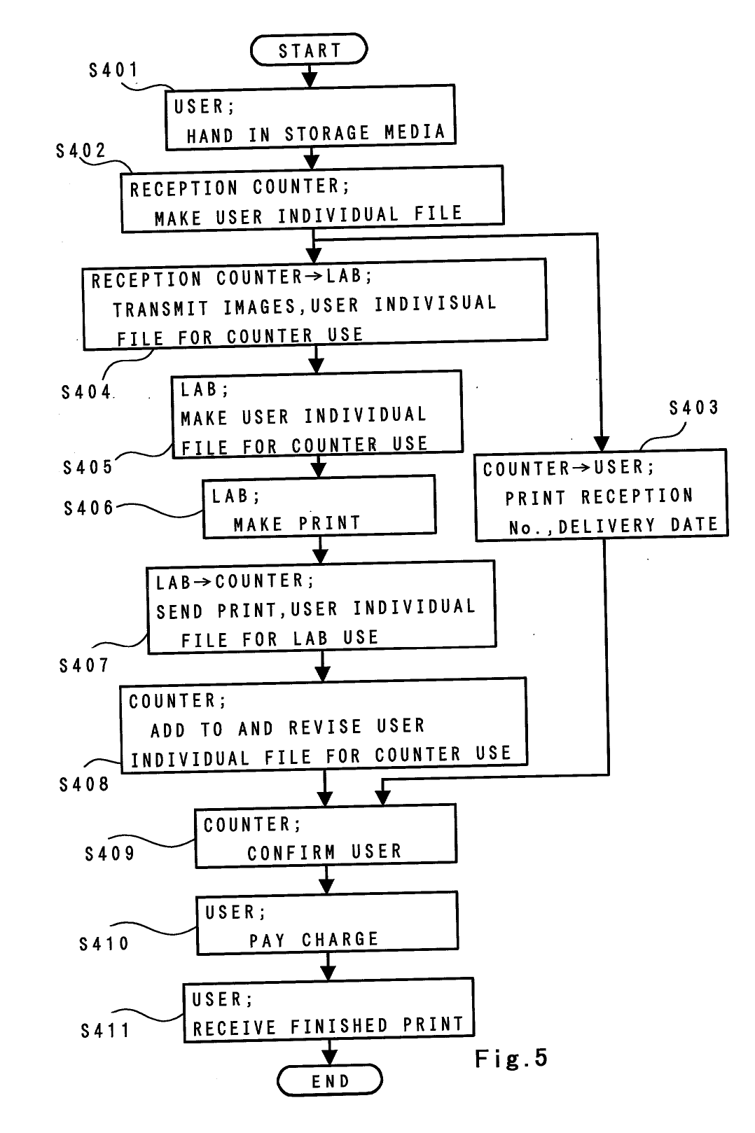

Now, the case that a small-scale handling counter such as a convenience store receives the print order will be explained using the block diagram of FIG. 2 and the flowchart of FIG. 5. In FIG. 2, items of the same function as FIG. 1 is fixed the same numerals as FIG. 1. First, the user stores the graphics data input to personal computer 102 from digital camera 103 or scanner 104 in such storage medium as a floppy disc or an MO disc and present it to handling counter 108 (FIG. 5 step S401, FIG. 2\mathring{1}). Reception counter 108 makes an individual user file for counter use explained earlier using FIGS. 8 and 9 (FIG. 5 step S402), prints a reception No. etc. on a slip and hand it to the user (FIG. 5 step S403, FIG. 2\mathring{2}). Reception counter 108, at the same time, transmits the image data and the individual user file for counter use to laboratory 106 of the print system that is designated by the user (FIG. 5 step S404, FIG. 2\mathring{3}).

Then, laboratory 106 makes an individual user file for laboratory use explained earlier using FIGS. 6 and 7 based on the individual user file for counter use (FIG. 5 step S405) and prints the pictures with printer 107 (FIG. 5 step S406), and sends the finished prints and the individual user file for laboratory use to service counter 108 (FIG. 5 step S407, FIG. 2\mathring{4}). Service counter 108 additionally fills in necessary items in the individual user file for counter use based on the individual user file for laboratory use sent from the laboratory (FIG. 5 step S408), confirms the user with a slip with the reception No. etc. handed to the user at the time of reception in FIG. 5 step S 403 (FIG. 5 step S409), receives the payment (FIG. 5 step S410, FIG. 2\mathring{5}) and hands the prints to the user (FIG. 5 step S411, FIG. 2\mathring{6}), thus the series of processes finish.

Contrary to the case of FIG. 1, in case of this FIG. 2, the user registration at the reception counter is completed at the time when the user presented the storage medium and the user registration of A Corporation is completed at the time when the image data (or a storage medium) and the individual user file are transmitted from the reception counter to the print system designated by the user. Later on, as far as the user uses the same print system and counter repeatedly, the best discount rate is applied to the user as in the case of FIG. 1.

Actually, there may be various cases for utilizing a print service other than the cases described in FIGS. 1 and 2, but in any case, basically the user will be free from disadvantages of current system, by making the most of a discount system proper to a laboratory or a counter, as explained above.

In individual user file for laboratory and counter use, regarding reception contents area, the item of that order No. is not deleted at the time when prints are handed to the user but it might better be stored in the computer of the laboratory or the counter as far as it has enough memory capacity, so that it can be used for user analysis later on.

When sending a user's order from the laboratory to the counter, or vice versa, it is enough to send items concerning to one reception No. together with data identifying the user among the contents of before-mentioned individual user file, but it might be better to send entire individual user file for counter use if the counter is affiliated to the laboratory so that it can be effectively used for user analysis, for instance, to know which system other than A corporation and to what extent the user uses. Of course, even if the counter is not affiliated, it will be the most favorable for the laboratory if an entire individual user file may be sent to the laboratory. Similarly it may be good for the reception counter so that it can cope with users better with differentiation.

So far the explanation is made to the charging system from the standpoint of the user who orders the prints and now the explanation will be made to the charging system from the standpoint of the image data ordered to make prints.

Regarding the method to judge whether or not the image data ordered to make prints this time is the one ordered before, there are four methods; a method to judge the file name affixed to the graphics data, a method to write the print history in the header of the image data, a method to judge from the print history attached, apart from the image data, and a method to judge from the print history embedded in the image data. Among these, for the first method of judging the file name, in the actual form, there may be a method judging if the file name coincides with the file name stored at the reception counter together with other data including reception date, etc. each time when a print order is placed. However, with this method, it is nearly impossible to form a system because image data with a same name appear repeatedly, because it is difficult to make reference with the stored data by the file name since the file name can easily be changed by the user, and because the number of image data ordered to print is too many. And, the second method of writing the print history in the header part will be applicable neither to the case that the ordinary graphics data alone was received, nor to the graphics data taken with the digital camera that does not adopt the format of adding the header to image data.

Now the later two methods of the above that decide the charge amount based on the print history written in the graphics data of every time will be described below.

The method to combine more than one image data or text data into one and new file and store it has been widely used since early times, and the file formats with extensions like ZIP or LZH are well known. The laboratory or the reception counter that received an order for prints from a user makes an individual user file in accordance with the graphics data, and converts this individual user file and graphics data into the above-mentioned one file format such as ZIP and after that, this new file format is processed, and if it is returned to the user in this file format, management of the print history for each image data becomes possible and at the user's end the reprint history can be confirmed. In case that the user does not wish the conversion of the file format, the image data may be returned in the form that was received, and in that case, the print history is not saved.

Now the system mentioned last will be described. The method to embed the text data directly on the image data for protection of the copy right or for security purpose is known as Steganography, Data Hiding or Digital Watermarking since earlier days. Utilizing this method, information regarding the past print history may be directly added to the image data at the laboratory or the reception counter that received an order for prints from a user, and, on the other hand, the user may keep the former method of viewing or storage as before.

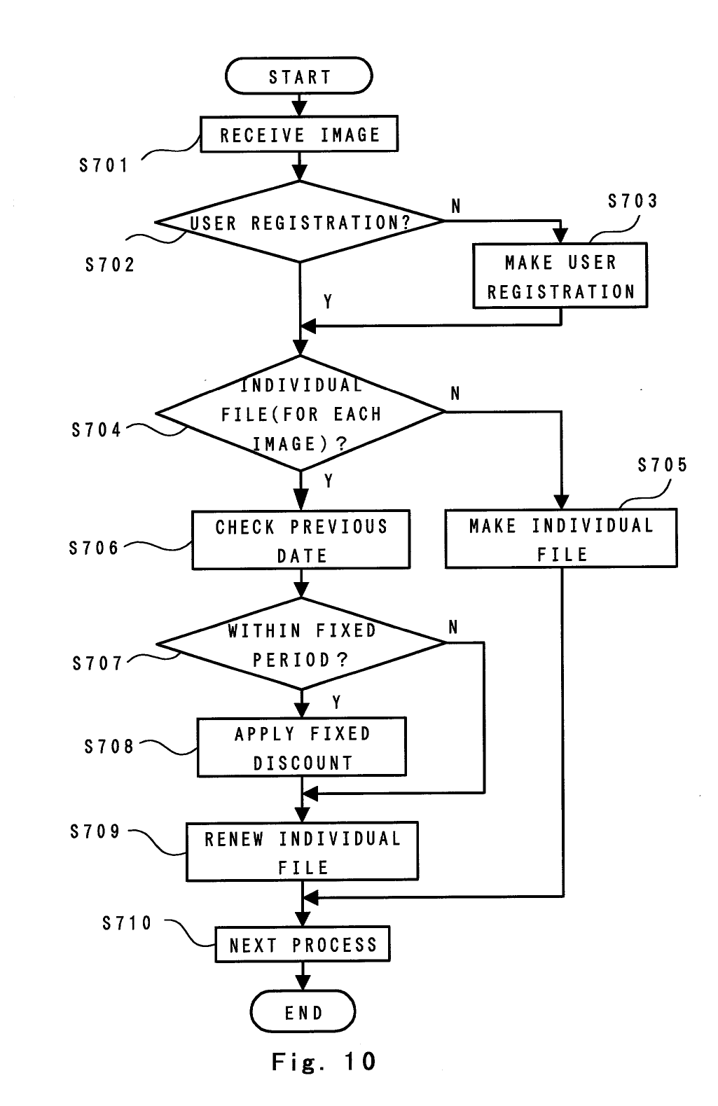

Now the form of charging in case that the print history is added to the image data in any of the above-mentioned methods will be explained based on the flowchart shown in FIG. 10.

After receiving an order for prints in step S701, the laboratory or the reception counter checks if the user who ordered prints is already registered at the laboratory or the reception counter in step S702. If the user is a new customer for the laboratory or the counter, user registration is made in step S703, and if it is confirmed in step S702 that the user has been already registered, it is to be checked if the individual file provided with the data identifying the user, data of previous order for prints and so on is affixed to each image or not in step S704.

For the image to which an individual file is not affixed in step S704, an individual file is made and is affixed to the image in step S705, and for the image with an individual file, the date of the previous order for prints at the same laboratory or the same counter is checked in step S706, and if it is within the predetermined period (for example, within a month) in step S707, the predetermined discount is applied to it in step S708. This predetermined discount means, for the reception counter, the discount for the basic charge for counter, and for the laboratory, the discount for the basic charge for laboratory, and the discount for the print charge may be included in addition.

The bounds for applying discount may be fixed freely, such as, applying the discount for all the prints ordered this time if at least one data applicable of discount is included in the ordered image data this time, or applying the discount for the image data within the discount applicable period alone. Or, the discount may be applied if the user is only registered, instead of applying discount for the predetermined period from the previous order.

If the discount amount is decided this way, the individual file is renewed and is affixed to image data in step S709 and the procedure is stepped to the next process in step S710. Here, the next process means, at the reception counter, from the process of sending the image data to the laboratory to the delivery of the prints to the user in the same manner as the user-centric operation as mentioned before, and at the laboratory, printing the ordered image data and sending the prints to the designated counter.

Taking the above-mentioned steps, the past history of print orders for each image data ordered for prints can be checked.

Regarding the method mentioned so far to determine whether or not the order is placed within the period to which the discount is applicable, there may be a method to compare the date of the previous order added the predetermined period with the date of this time, or conversely, to check whether or not the previous order was placed within the period deducted the prescribed period from the date of this time, or to check whether or not the period from the previous order to the current order is within the prescribed period, among these, the method most suitable to the system operated by the laboratory or the service facilities may be adopted.

1. A print service for providing print of digital image data in response to an order from a user comprising:
a recorder that records reception date of an order from the user and data identifying the user;
a checker that checks whether or not a previous order from the same user is in the record of the recorder within a predetermined period prior to the order of this; and
a charge determiner that deducts a predetermined amount from the print charge on the order of this time regardless of that on the previous order if the checker finds the previous order in the record.

2. The print service according to claim 1, wherein the predetermined period is less than one month.

3. The print service according to claim 1, wherein the checker includes a comparator that compares the user of the order of this time with the data identifying the user in the record.

4. The print service according to claim 1, wherein the checker includes a comparator that finds out a relationship between the data of the order and the reception data in the record in view of the predetermined period.

5. The print service according to claim 4, wherein the comparator includes an adder that adds the predetermined period to the reception date in the record to compare it with the date of the order of this time.

6. The print service according to claim 4, wherein the comparator includes a subtractor that subtracts the predetermined period from the date of the order of this time to compare it with the reception date in the record.

7. The print service according to claim 4, wherein the comparator includes a finder that finds a period between the date of the order of this time and the reception date in the record to compare it with the predetermined period.

8. The print service according to claim 1, wherein the checker checks up if the user used the same print service within the predetermined period.

9. The print service according to claim 1 further comprising a reception that receives the order, wherein the checker checks up if the order is through the same reception within the predetermined period.

10. The print service according to claim 1, wherein the contents to be recorded by the recorder are attached to the digital image data.

11. The print service according to claim 1, wherein the contents to be recorded by the recorder are embedded in the digital image data.

12. The print service according to claim 1, wherein a plurality of predetermined periods are prepared in the checker.

13. The print service according to claim 12, wherein the charge determiner deducts one of a plurality of predetermined amount from the print charges to cope with one of the predetermined periods.

14. A print service for providing print of digital image data in response to an order from a user comprising:
a recorder that records reception date of an order from the user and data identifying the user;
a checker that checks whether or not a previous order from the same user is in the record of the recorder within one month prior to the order of this time; and
a charge determiner that deducts an amount from the print charge on the order of this time if the checker finds the previous order in the record.

15. The print service according to claim 14 further comprising a reception that receives the order, wherein the checker checks up if the user used the same print service within the predetermined period.

16. The print service according to claim 14, wherein the checker checks up if the order is through the same service front within the predetermined period.

17. The print service according to claim 14 further comprising a laboratory system that produces the print in response to the order received through the service front.

18. The print service according to claim 14, wherein the contents to be recorded by the recorder are attached to the digital image data.

19. The print service according to claim 14, wherein the contents to be recorded by the recorder are embedded in the digital image data.

20. In a print service for providing print of digital image data in response to an order from a user, a laboratory system comprising:
a recorder that records data identifying the user;
a checker that checks whether or not the user used the same laboratory system before according to the record;
a determiner that determines the print charge on the order of this time in response to the checker; and
a reporter that reports the outcome of the determiner to a service front that contacts the user.

21. The laboratory system according to claim 20, wherein the determiner deducts a predetermined amount from the print charge on the order of this time regardless of that on the previous order by the same user if it is confirmed by the checker that the user used the same laboratory system before.

22. The laboratory system according to claim 20, wherein the service front is apart from the laboratory.

23. The laboratory system according to claim 20, wherein the checker checks up if the data identifying the user same as that of the order this time has been recorded before.

24. The laboratory system according to claim 20 further comprising a second recorder that records the service front receiving the order, wherein the reporter reports the service front recorded in the second recorder.

25. The laboratory system according to claim 20 further comprising a second recorder that records the service front in charge of the delivery of the prints to the user, wherein the reporter reports the service front recorded in the second recorder.

26. The laboratory system according to claim 20, wherein the contents to be recorded by the recorder are attached to the digital image data.

27. The laboratory system according to claim 20, wherein the contents to be recorded by the recorder are embedded in the digital image data.

28. In a print service for providing a print of digital image data in response to an order from a user through a service front, the service front comprising:
a first recorder that records data identifying the user;
a second recorder that records a laboratory system, the service front requesting the recorded laboratory system to produce the print;
a checker that checks whether or not the user used the same service front before according to the record of the first recorder; and
a determiner that determines the print charge on the order of this time in response to the checker regardless of the record of the second recorder.

29. The service front according to claim 28 further comprising a requester that requests the print to the laboratory system based on the second recorder.

30. The service front according to claim 28 further comprising a receiver that receives a report of a charge determined by the laboratory, and a charging system that charges the user the total amount of the reported charge and the charge determined by the determiner.

31. The service front according to claim 28, wherein the service front acts as a reception site that receives an order for printing images from the user.

32. The service front according to claim 28, wherein the service front acts as a delivery site that delivers the print output to the user.

33. The service front according to claim 28, wherein the determiner determines lower charge if it is confirmed by the checker that an order from the same user was received within a predetermined period prior to the order of this time.

34. The service front according to claim 28, wherein the predetermined period is less than one month.

35. The service front according to claim 28, wherein the checker checks up if the data identifying the user same as that of the order this time has been recorded before.

36. The service department according to claim 28, wherein the contents to be recorded by the first and second recorders are attached to the digital image data.

37. The service department according to claim 28, wherein the contents to be recorded by the first and second recorders are embedded in the digital image data.
